(19) United States
(12) Patent Application Publication
(10) Pub. No.: US 2012/0097805 A1
(43) Pub. Date: Apr. 26, 2012

(54) Medical conduit organizer and methods for securing and organizing a plurality of medical conduits

(75) Inventor: Douglas Goumas, Bedford, NH (US)

(73) Assignee: G Force Braces, LLC, Bedford, NH (US)

(21) Appl. No.: 12/925,484

(22) Filed: Oct. 22, 2010

(51) Int. Cl. F16L 3/22; F16B 2/20; B23P 11/00; A44B 18/00

(52) U.S. Cl. 248/69; 248/68.1; 29/525.01

(57) ABSTRACT

A medical conduit organizer is provided along with corresponding methods for securing and organizing a plurality of medical conduits. The conduit organizer comprises an elongated base comprised of a flexible material, a plurality of areas on the base each of which is adapted to receive a medical conduit, and at least one respective tab for each of the areas adapted to secure the medical conduit in the respective area. A respective first end of each of the tabs may be fixed to the base adjacent the respective area. By providing at least one separate tab for securing a single conduit in each respective area, conduits can easily be added or removed from the organizer without disturbing or removing other conduits that are fixed in the organizer.

### BACKGROUND OF THE INVENTION

The present invention relates to the field of medical instrumentation. More specifically, the present invention relates an apparatus and methods for organizing medical conduits, such as power cords, sensor leads, tubes, and the like used in a hospital patient's room or an operating room.

In a hospital environment, such as a patient room or an operating room, there are typically several conduits, including power cords, sensor leads, IV and other tubes, and the like leading from a number of medical devices to a patient and/or between various medical devices. Such conduits can become entangled and unorganized, leading to confusion, medical errors, and accidents.

It would be advantageous to provide a solution for organizing and securing a plurality of medical conduits in a simple manner. It would be advantageous if such a solution enabled a single conduit to be easily added or removed from a conduit organizing device without the need to remove or disturb other conduits already secured in the device. It would also be advantageous if such a device were easy to use, affordable, and made of a soft material that would not harm the conduits, the medical equipment, or the patient.

The apparatus and methods of the present invention provide the foregoing and other advantages.

### SUMMARY OF THE INVENTION

The present invention relates to apparatus and methods for organizing medical conduits, such as power cords, sensor leads, tubes, and the like used in a hospital patient's room or an operating room.

In accordance with one example embodiment of the present invention, a medical conduit organizer is provided. The conduit organizer comprises an elongated base comprised of a flexible material, a plurality of areas on the base each of which is adapted to receive a medical conduit, and a respective tab for each of the areas adapted to secure the medical conduit in the respective area. A respective first end of each of the tabs may be fixed to the base adjacent the respective area.

Each of the tabs may comprise a strip of flexible material. In one example embodiment, at least a portion of the flexible material of the base may comprise a first Velcro material and at least a portion of each of the tabs may comprise a second Velcro material adapted for removable connection to the first Velcro material of the base. For example, at least a portion of the base adjacent each area may comprise a first Velcro material and a second free end of each of the tabs may comprise a second Velcro material adapted for removable connection to the first Velcro material of the base. Each of the tabs may be comprised entirely of the second Velcro material.

In a further example embodiment, the flexible material of the base may comprise one of cloth or thin plastic. The tabs may also comprise one of cloth or thin plastic. At least a portion of the cloth or thin plastic of the base may be provided with a first Velcro material, and at least a portion of the cloth or thin plastic of the tabs may be provided with a second Velcro material adapted for removable connection to the first Velcro material of the base.

The first end of each of the tabs may be one of sewn into, glued onto, or formed with the base.

A flap may be provided on the second free end of each of the tabs. Once the second end of the tab is pulled over the conduit and secured to the base, the conduit can be released from the organizer by pulling on the flap, causing the second end of the tab to release from the base.

Securing means may be provided for attaching the base to one of a sheet-like material, a piece of medical equipment, and a bed. The securing means may be either fixed to or integral with the base. For example, the securing means may comprise a clip or other similar device.

The areas may be defined by respective pairs of spaced apart parallel ridges on the base. The first end of each of the respective tabs may be fixed to the base adjacent a first ridge of each respective pair of ridges. Each of the tabs may be adapted to span at least the respective area between the corresponding pair of ridges. A second free end of each of the tabs may be adapted to be removably attached to the base adjacent a second ridge of each respective pair of ridges to secure the medical conduit between the respective pair of ridges. Each pair of ridges may define a concave portion adapted to accept the conduit.

In one example embodiment, at least one of the ridges and a portion of the flexible material of the base may comprise a first Velcro material, and at least a portion of each of the tabs may comprise a second Velcro material adapted for removable connection to the first Velcro material.

In a further example embodiment, a pair of spaced apart tabs may be provided for each respective area, each pair of tabs defining the area. The tabs of each pair of tabs may be adapted to overlap each other above the conduit to secure the conduit in the respective area.

The areas may be of varying size to accommodate varying types and sizes of conduits. The conduits may comprise at least one of power cords, sensor leads, tubes, and the like. In addition (or alternatively) one or more of the areas may be adapted to accommodate two conduits. One skilled in the art will appreciate that the term conduit as used herein includes any and all types of leads, cables, tubes, wires and the like that may be found in a hospital environment.

The organizer may be manufactured under sterile conditions, sterilized after manufacture, and/or packaged in sterile packaging.

A method for securing and organizing a plurality of medical conduits is also provided in accordance with the present invention. In one example embodiment of such a method, an elongated base comprised of a flexible material is provided. A plurality of areas are provided on the base, each of which is adapted to receive a medical conduit. A respective tab is provided for each of the areas. Each tab is adapted to secure the medical conduit in the respective area, a respective first end of each of the tabs being fixed to the base adjacent the respective area. At least one of the medical conduits is positioned in at least one of the respective areas. The at least one medical conduit can then be secured in the at least one area by pulling a second end of the respective tab over the conduit and removably attaching the second end of the tab to the base.

The method may also include providing additional features and elements discussed above in connection with the medical conduit organizer.

### BRIEF DESCRIPTION OF THE DRAWINGS

The present invention will hereinafter be described in conjunction with the appended drawing figures, wherein like reference numerals denote like elements, and:

FIG. 1 shows a side view of an example embodiment of a conduit organizer in accordance with the present invention;

FIG. 2 shows an example embodiment of a top view of the base of the conduit organizer of FIG. 1 (without tabs for clarity);

FIG. 3 shows a further example embodiment of a conduit organizer in accordance with the present invention.

FIG. 4 shows a further example embodiment of a conduit organizer in accordance with the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

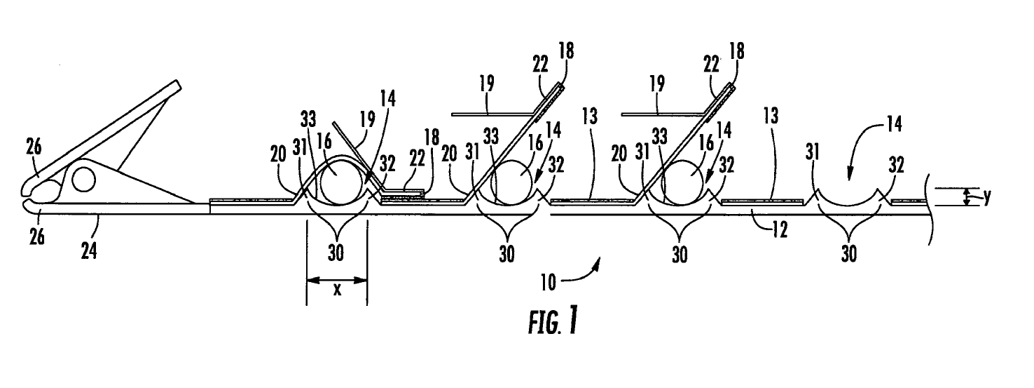

In accordance with the present invention, a medical conduit organizer is provided along with corresponding methods for securing and organizing a plurality of medical conduits. FIG. 1 shows a conduit organizer 10 in accordance with one example embodiment of the present invention. The conduit organizer comprises an elongated base 12 comprised of a flexible material, a plurality of areas 14 on the base 12 each of which is adapted to receive a medical conduit 16, and a respective tab 18 for each of the areas 14 adapted to secure the medical conduit 16 in the respective area 14. A respective first end 20 of each of the tabs 18 may be fixed to the base 12 adjacent the respective area 14. For clarity, one of the areas 14 is shown without a corresponding tab 18 in FIG. 1.

By providing a separate tab 18 for securing a single conduit 16 in each respective area 14, conduits 16 can easily be added or removed from the organizer 10 without disturbing or removing other conduits 16 that are fixed in the organizer 10.

Each of the tabs 18 may comprise a strip of flexible material. In one example embodiment, at least a portion of the flexible material of the base 12 may comprise a first Velcro material and at least a portion of each of the tabs 18 may comprise a second Velcro material adapted for removable connection to the first Velcro material of the base 12.

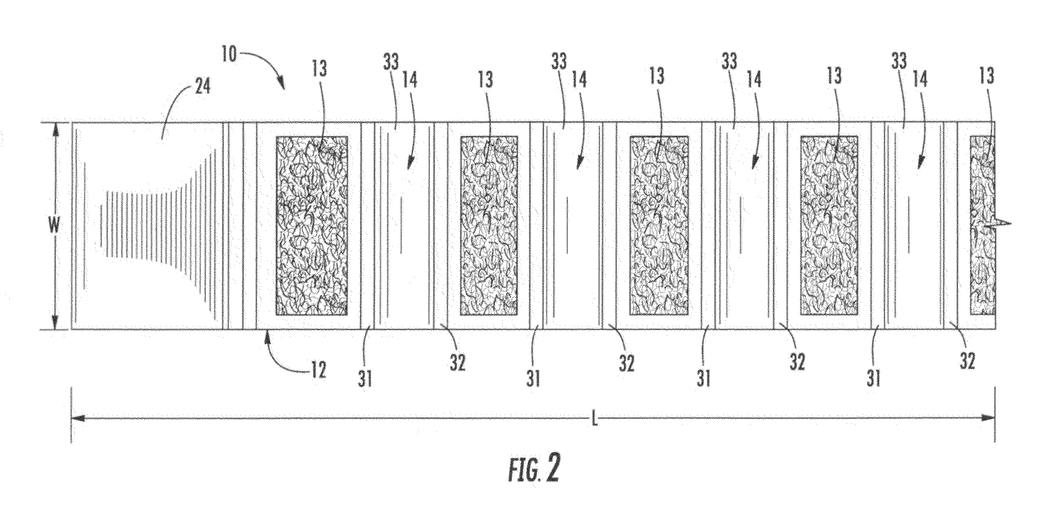

FIG. 2 shows an example embodiment of a top view of the base 12 of the conduit organizer of FIG. 1. The tabs 18 are not shown in FIG. 2 for clarity. At least a portion 13 of the base 12 adjacent each area 14 may comprise a first Velcro material and a second free end 22 of each of the tabs 14 may comprise a second Velcro material adapted for removable connection to the first Velcro material of the base 12. It should be appreciated that each of the tabs 18 may be comprised entirely of the second Velcro material. Likewise, the entire base 12 may be comprised of the first Velcro material.

In a further example embodiment, the flexible material of the base 12 may comprise one of cloth or thin plastic. The tabs 18 may also comprise one of cloth or thin plastic. At least a portion of the cloth or thin plastic of the base 12 may be provided with a first Velcro material, and at least a portion of the cloth or thin plastic of the tabs 18 may be provided with a second Velcro material adapted for removable connection to the first Velcro material of the base 12. Other flexible materials may be used for the base 12 or tabs 18 as will be appreciated by those of ordinary skill in the art.

By making both the base 12 and the tabs 18 out of a flexible material, there is no danger of damage to the conduits 16 or any medical equipment, and no danger of injury to a patient that may come into contact with the organizer.

The first end 20 of each of the tabs 18 may be one of sewn into, glued onto, or formed with the base 12. Optionally the first ends 20 of the tabs 18 may be removably attached to the base 12, for example using Velcro or the like.

FIG. 1 shows one of the tabs 18 (the leftmost tab 18) in a position in which it is pulled over the conduit 16 and the second free end 22 of the tab 18 is secured to the corresponding portion 13 of the base 12. A flap 19 may be provided on the second free end 22 of each of the tabs 18. Once the second end 22 of a tab 18 is pulled over the conduit 16 and secured to the base 12, the conduit 16 can be released from the organizer 10 by pulling on the flap 19, causing the second end 22 of the tab 18 to release from the base 12. The flap 19 may extend transversely from the tab 18 and be connected to the tab 18 by one of glue, stitching, Velcro, or the like. Alternatively, the flap 19 may be integral to the tab 18.

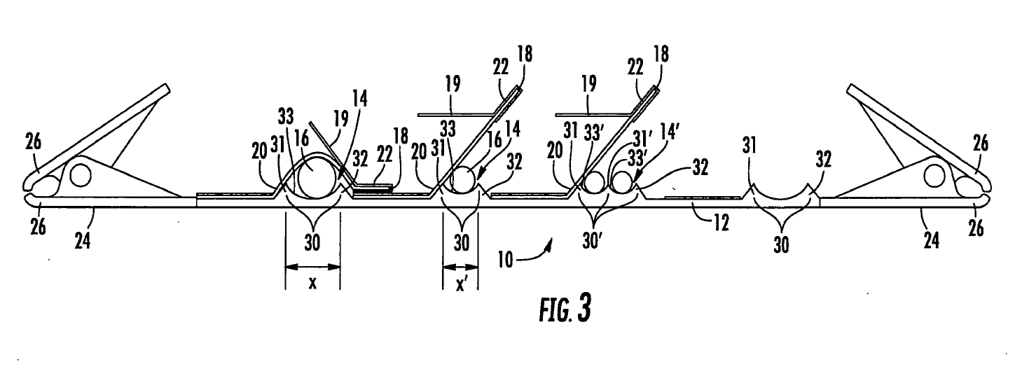

Securing means 24 may be provided for attaching the base 12 to one of a sheet-like material, a piece of medical equipment, and a bed. For example, the securing 24 means may comprise a clip or other similar device. The securing means 24 may be fixed to or integral with one end of the base 12. Alternatively, two securing means 24 may be provided, with each securing means 24 being arranged at opposite ends of the base 12 (as discussed below and shown in FIG. 3). The clip 24 may be a spring biased alligator-type clip with blunt jaws 26 that will not puncture the sheet-like material and will not damage medical equipment. Those skilled in the art will appreciate that the securing means 24 may comprise almost any known type of clip, clamp, adhesive, or the like. The securing means 24 may be fixed to the base 12 in a variety of ways (e.g., by screws, rivets, glue, Velcro, staples, or the like). Altervatively, the securing means 24 can be formed in one piece with the base 12 (e.g., in an injection molding process). Those skilled in the art will appreciate that the entire organizer 10, including the clip 24, may be formed in one piece in, for example, an injection molding process. In addition, portions of the organizer may be formed in one piece (e.g., the entire base 12 as shown in FIG. 2) with remaining parts (e.g., the tabs 18) formed separately.

The areas 14 may be defined by respective pairs 30 of spaced apart parallel ridges 31, 32 on the base 12. The first end 20 of each of the respective tabs 18 may be fixed to the base 12 adjacent a first ridge 31 of each respective pair of ridges 30. Each of the tabs 18 may be adapted to span at least the respective area 14 between the corresponding pair of ridges 30 with a conduit 16 positioned in the area 14. A second end 22 of each of the tabs 18 may be adapted to be removably attached to the base 12 adjacent a second ridge 32 of each respective pair of ridges 30 to secure the medical conduit 16 between the respective pair of ridges 30. The ridges 31, 32 may also be made with or covered by the same first Velcro material of the base 12, so that the tabs 18 may be secured to the base 12 and/or the ridges 31, 32.

As shown in FIG. 1, each pair of ridges 30 may define a concave portion 33 adapted to accept the conduit 16.

The areas 14 may be of varying size to accommodate varying types and sizes of conduits 16. For example, the space x between the ridges 31, 32 of each respective pair of ridges 30 may vary. For example, the area 14 defined by each respective pair of ridges 30 may be between about ½ cm to 3 cm. The ridges 31, 32 themselves need only have a height y that is sufficient to retain the conduits. For example, the ridges 31, 32 may be between about 3 mm to 6 mm high.

The base 12 may have a width w of about 4 cm to 6 cm wide. The organizer 10 may be manufactured with bases 12 of different lengths l to accommodate different numbers of conduits 16. For example, the organizer 10 may be made with a base length l that accommodates 3 areas 14 for three conduits 16, or with a base length l that accommodates ten areas 14 for ten or more conduits 16. Those skilled in the art will appreciate that the base 12 can be, made in almost any length l, depending on the number of conduits 16 to be secured therein.

It should be appreciated that the term Velcro as used herein is defined to mean the commonly known Velcro material as well as all similar types of materials. Other interlocking connectors may also be used in place of the Velcro material, as will be apparent to those of ordinary skill in the art.

FIG. 3 shows an example embodiment of the present invention similar to that shown in FIG. 1. However, in FIG. 3, areas 14 on the base 12 are of different widths x and x′ to accommodate cords 16 of different sizes. In addition, one or more areas 14′ may be provided that has two small concave sections 33′ (instead of a single, larger, concave portion 33 as in FIG. 1). Accordingly, the sections 33′ are each adapted to retain a single smaller conduit 16. The portions 33′ are defined by a group 30′ of three ridges, ridges 31, 32 (as discussed above in connection with FIG. 1), and an additional ridge 31′ disposed between ridges 31 and 32, such that each pair of ridges (31 and 31′; 31′ and 32) defines one of the concave sections 33′, each concave section 33′ adapted to receive a small conduit 16. The two smaller conduits 16 can be secured in the area 14′ by a single flap 18. The FIG. 3 example embodiment also shows securing means 24 (e.g., clips or the like) at both ends of the base 12.

Those skilled in the art will appreciate that various features of the FIG. 1 embodiment (in which all areas are of essentially the same size and design) and various features of the FIG. 3 embodiment (in which differently sized areas 14 and areas 14′ are provided) can be combined in various ways to produce additional embodiments of the present invention (for example, an organizer 10 having all areas 14′, an organizer 10 in which all areas 14 are of different sizes, an organizer having 3 or more differently sized areas 14 and/or 14′, as well as other combinations that would be apparent to one of ordinary skill in the art from the FIG. 1 and FIG. 3 embodiments, any or which may have securing means 24 at one or both ends).

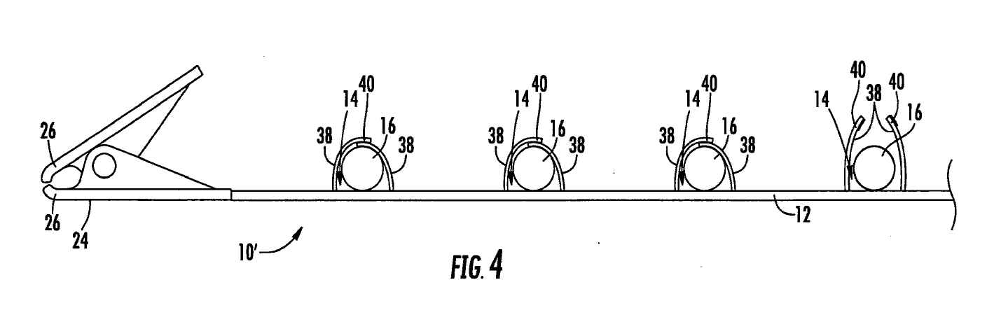

A further example embodiment of a medical conduit organizer 10′ is shown in FIG. 4. The medical conduit organizer 10′ of FIG. 4 is similar to the organizer 10 shown in FIGS. 1 and 2, with the exception that the areas 14 for the conduits 16 are not defined by pairs of ridges (as is the case with FIGS. 1 and 2). Rather, the areas 14 are defined by respective pairs of spaced apart strips or tabs 38 that are also used to secure the respective conduits 16 in the respective areas 14. The tabs 38 may run approximately the width w of the base 12, and be of such a length that that, when the conduit 16 is positioned between the tabs 18, the tabs overlap on top of the conduit 16 and can be joined together (e.g., via the Velcro material), securing the conduit 16 to the base 12. FIG. 4 shows an example wherein two conduits 16 are secured by overlapping tabs 38 and one conduit 16 is place in an area 14 but the tabs 38 have not yet been overlapped and joined together above the conduit 16. Like tabs 18, the smaller tabs 38 shown in FIG. 4 may be made entirely of Velcro material, or only the end portions 40 may be made of Velcro material. Of course, the two ends 40 of each pair of tabs 38 may be made of first and second Velcro material, respectively, such that the ends 40 engage with each other. In addition, a first end of each of the tabs 38 may be fixed to the base 12.

Those skilled in the art will appreciate that other means of securing the conduits 16 in the areas 14 of the base are also within the scope of the present invention. For example, a plurality of flexible C-shaped retaining clips may be fixed to the base 12, each C-shaped retaining clip defining a respective area 14 for a conduit 16. A conduit 16 may simply be pressed into the flexible C-shaped retaining clip and secured therein by resilient arms of the C-shaped clip. For removal of the conduit 16, the conduit 16 is lifted out of the C-shaped retaining clip against a retaining force of the resilient arms. In such an embodiment employing C-shaped clips, the cord organizer can be made from rubber or soft plastic and formed as a one piece unit by an injection molding process.

The conduits 16 may comprise at least one of power cords, sensor leads, tubes, and the like. One skilled in the art will appreciate that the term conduit as used herein includes any and all types of leads, cables, tubes, wires and the like that may be found in a hospital environment.

The cord organizer 10, 10′ may be either manufactured under sterile conditions, sterilized after manufacture, and/or packaged in sterile packaging. Accordingly, the cord organizer 10, 10′ may be ready to use in a sterile environment or other locations where sterility is required or advantageous, such as an operating room, intensive care unit, patient room, or the like.

A method for securing and organizing a plurality of medical conduits is also provided in accordance with the present invention. In one example embodiment of such a method, an elongated base 12 comprised of a flexible material is provided. A plurality of areas 14 are provided on the base 12, each of which is adapted to receive a medical conduit 16. A respective tab 18 is provided for each of the areas 14. Each tab 18 is adapted to secure the medical conduit 16 in the respective area 14, a respective first end 20 of each of the tabs 18 being fixed to the base 12 adjacent the respective area 14. At least one of the medical conduits 16 is positioned in at least one of the respective areas 14. The at least one medical conduit 16 can then be secured in the at least one area 14 by pulling a second end 22 of the respective tab 18 over the conduit 16 and removably attaching the second end 22 of the tab 18 to the base 12.

It should now be appreciated that the present invention provides advantageous methods and apparatus for securing and organizing a plurality of medical conduits.

Although the invention has been described in connection with various illustrated embodiments, numerous modifications and adaptations may be made thereto without departing from the spirit and scope of the invention as set forth in the claims.

What is claimed is:

1. Medical conduit organizer, comprising:
an elongated base comprised of a flexible material;
a plurality of areas on the base each of which is adapted to receive a medical conduit; and
a respective tab for each of the areas adapted to secure the medical conduit in the respective area, a respective first end of each of the tabs being fixed to the base adjacent the respective area.

2. Medical conduit organizer in accordance with claim 1, wherein:
each of the tabs comprises a strip of flexible material;
at least a portion of the base adjacent each area comprises a first Velcro material; and
a second end of each of the tabs comprises a second Velcro material adapted for removable connection to the first Velcro material of the base.

3. Medical conduit organizer in accordance with claim 2, wherein each of the tabs is comprised entirely of the second Velcro material.

4. Medical conduit organizer in accordance with claim 1, wherein the first end of each of the tabs is one of sewn into, glued onto, or formed with the base.

5. Medical conduit in accordance with claim 1, wherein:
the flexible material of the base comprises one of cloth or thin plastic;
the tabs comprise one of cloth or thin plastic;
at least a portion of the cloth or thin plastic of the base is provided with a first Velcro material; and
at least a portion of the cloth or thin plastic of the tabs is provided with a second Velcro material adapted for removable connection to the first Velcro material of the base.

6. Medical conduit organizer in accordance with claim 1, wherein:
at least a portion of the flexible material of the base comprises a first Velcro material; and
at least a portion of each of the tabs comprises a second Velcro material adapted for removable connection to the first Velcro material of the base.

7. Medical conduit organizer in accordance with claim 1, further comprising:
securing means for attaching the base to one of a sheet-like material, a piece of medical equipment, and a bed;
wherein said securing means is one of fixed to or integral with the base.

8. Medical conduit organizer in accordance with claim 7, wherein the securing means comprises a clip.

9. Medical conduit organizer in accordance with claim 1, wherein the areas are defined by respective pairs of spaced apart parallel ridges on the base.

10. Medical conduit organizer in accordance with claim 9, wherein:
the first end of each of the respective tabs is fixed to the base adjacent a first ridge of each respective pair of ridges;
each of the tabs is adapted to span at least the respective area between the corresponding pair of ridges; and
a second end of each of the tabs is adapted to be removably attached to the base adjacent a second ridge of each respective pair of ridges to secure the medical conduit between the respective pair of ridges.

11. Medical conduit organizer in accordance with claim 9, wherein:
at least one of the ridges and a portion of the flexible material of the base comprises a first Velcro material; and
at least a portion of each of the tabs comprises a second Velcro material adapted for removable connection to the first Velcro material.

12. Medical conduit organizer in accordance with claim 1, wherein at least one of:
the areas are of varying size to accommodate varying types and sizes of conduits; and
one or more of the areas are adapted to accommodate two conduits.

13. Medical conduit organizer in accordance with claim 1, wherein:
a pair of tabs are provided for each respective area, each pair of tabs defining said area;
the tabs of each pair of tabs are adapted to overlap each other above the conduit to secure the conduit in the respective area.

14. Medical conduit organizer in accordance with claim 1, wherein the conduits comprise at least one of power cords, sensor leads, and tubes.

15. Medical conduit organizer in accordance with claim 1, wherein the organizer is at least one of manufactured under sterile conditions, sterilized after manufacture, and packaged in sterile packaging.

16. Medical conduit organizer in accordance with claim 1, further comprising:
a flap connected to a second free end of each of the tabs.

17. A method for securing and organizing a plurality of medical conduits, comprising:
providing an elongated base comprised of a flexible material;
providing a plurality of areas on the base each of which is adapted to receive a medical conduit;
providing a respective tab for each of the areas adapted to secure the medical conduit in the respective area, a respective first end of each of the tabs being fixed to the base adjacent the respective area;
positioning at least one of the medical conduits in at least one of the respective areas; and
securing the at least one medical conduit in the at least one area by pulling a second end of the respective tab over the conduit and removably attaching the second end of the tab to the base.

18. Method in accordance with claim 17, wherein:
each of the tabs comprises a strip of flexible material;
at least a portion of the base adjacent each area comprises a first Velcro material; and
a second end of each of the tabs comprises a second Velcro material adapted for removable connection to the first Velcro material of the base.

19. Method in accordance with claim 18, wherein each of the tabs is comprised entirely of the second Velcro material.

20. Method in accordance with claim 17, wherein the first end of each of the tabs is one of sewn into, glued onto, or formed with the base.

21. Method in accordance with claim 17, wherein:
the flexible material of the base comprises one of cloth or thin plastic;
the tabs comprise one of cloth or thin plastic;
at least a portion of the cloth or thin plastic of the base is provided with a first Velcro material; and
at least a portion of the cloth or thin plastic of the tabs is provided with a second Velcro material adapted for removable connection to the first Velcro material of the base.

22. Method in accordance with claim 17, wherein:
at least a portion of the flexible material comprises a first Velcro material; and
at least a portion of each of the tabs comprises a second Velcro material adapted for removable connection to the first Velcro material of the base.

23. Method in accordance with claim 17, further comprising:
securely attaching the base to one of a sheet-like material, a piece of medical equipment, and a bed.

24. Method in accordance with claim 17, wherein the areas are defined by respective pairs of spaced apart parallel ridges on the base.

25. Method in accordance with claim 24, wherein:
the first end of each of the respective tabs is fixed to the base adjacent a first ridge of each respective pair of ridges;
each of the tabs is adapted to span at least the respective area between the corresponding pair of ridges; and
a second end of each of the tabs is adapted to be removably attached to the base adjacent a second ridge of each respective pair of ridges to secure the medical conduit between the respective pair of ridges.

26. Method in accordance with claim 24, wherein:
at least one of the ridges and a portion of the flexible material of the base comprises a first Velcro material; and
at least a portion of each of the tabs comprises a second Velcro material adapted for removable connection to the first Velcro material.

27. Method in accordance with claim 17, wherein at least one of:
the areas are of varying size to accommodate varying types and sizes of conduits; and
one or more of the areas are adapted to accommodate two conduits.

28. Method in accordance with claim 17, wherein:
a pair of tabs are provided for each respective area, each pair of tabs defining said area; and
the tabs of each pair of tabs are adapted to overlap each other above the conduit to secure the conduit in the respective area.

29. Method in accordance with claim 17, wherein the conduits comprise at least one of power cords, sensor leads, and tubes.

30. Method in accordance with claim 17, further comprising at least one of manufacturing the organizer under sterile conditions, sterilizing the organizer after manufacture, and packaging the organizer in sterile packaging.

31. Method in accordance with claim 17, wherein a flap is provided which is connected to a second free end of each of the tabs.
